(19) United States
(12) Patent Application Publication
(10) Pub. No.: US 2013/0035199 A1
(43) Pub. Date: Feb. 7, 2013

(54) Apparatus and method for transferring torque

(71) Applicants: Eric Stiene, East Norwich, NY (US); Dennis G. Berg, West Babylon, NY (US)

(72) Inventors: Eric Stiene, East Norwich, NY (US); Dennis G. Berg, West Babylon, NY (US)

(73) Assignees: Rino Mechanical Components Inc.; Ondrives.US Corp., Freeport, NY (US)

(21) Appl. No.: 13/136,514

(22) Filed: Aug. 3, 2011

(51) Int. Cl. F16H 13/04; F16H 37/02

(52) U.S. Cl. 476/31; 476/36

(57) ABSTRACT

A traction drive apparatus is provided for transferring torque from an input rotating shaft to an in-line, or co-axial, output rotating shaft. More specifically, the invention is a gearless, friction drive, in-line, rotating speed reducer or speed increaser for use in a wide variety of rotating equipment applications. The apparatus of the instant invention employs a retainer of a plurality of bearing means to transfer torque from an input shaft to an output shaft, wherein the retainer is either non-rotating or rotating.

### FIELD OF THE INVENTION

This invention concerns generally with an apparatus and a method for transferring torque from an input rotating shaft to an output rotating shaft. More specifically, the invention is a friction drive rotating speed reducer or speed increaser for use in a wide variety of rotating equipment.

### BACKGROUND

Planetary gear systems have found significant use in many applications including automatic car transmissions and industrial equipment, as well as many others. Planetary gear systems are made of a central sun gear that rotates about a longitudinal axis and that is surrounded by one or more sets of planet gears. The planet gears in a plane surround the sun gear with each of their respective peripheral edges engaging the sun gear at its outer surface. A ring gear surrounds the planet gears and engages the peripheral edge of each of the planet gears at their radially outermost point from the longitudinal axis. Each of the planet gears rotates about a planet shaft that forms its own axis. A planet carrier holds all of the planet shafts in their alignment and spatial distribution about the sun gear. The planet carrier is typically a disc or some other structure that is mounted coaxially about the longitudinal axis and can be capable of rotating about the longitudinal axis.

However, the meshing of gear teeth in many existing planetary gear sets requires overcoming sliding friction that occurs as each gear tooth of one gear meshes with a corresponding tooth on another gear. The friction of this meshing is converted to heat, noise and deformation of the gears, and is therefore not transferred out of the gear set, resulting in a reduced efficiency of the gear set. This reduced efficiency is not satisfactory for many applications and an alternative type of reduction or step-up drive would be beneficial. While design alternatives to standard gear teeth exist that greatly improve the efficiency of such gear designs, such designs still do not provide a high efficiency at a low cost. Furthermore, it would be beneficial for a planetary gear set to achieve any or all of the following as well; a large speed change, the ability to produce any speed change ratio, the capacity for a very high rotational speed, a low manufacturing cost, long component life, very low or essentially no backlash, or any combination of these. These and other advantages are achieved by some or all of the embodiments described herein.

### SUMMARY OF THE INVENTION

The systems and methods described herein have several features, no single one of which is solely responsible for the overall desirable attributes. Without limiting the scope as expressed by the claims that follow, the more prominent features of certain embodiments of the invention will now be discussed briefly.

In one embodiment, the present invention is a speed reducer/increaser organized about a center axis. The speed reducer/increaser comprises a plurality of bearing means; a first shaft member, a second shaft module, a retainer member, a housing, and a positioning means for positioning the second shaft module within the housing. The first shaft member module comprises a first shaft member that has a first shaft proximal end and a first shaft distal end. A first shaft bearing means is disposed on the first shaft member coaxially. The second shaft module comprises a second shaft member having a second proximal end and a second distal end. A second shaft bearing means disposed on the second shaft member coaxially. The second proximal end of the second shaft module is adapted to contact each of the plurality of bearing means. The retainer member is adapted to retain and permit the rotation of each of the plurality of bearing means in a plane that is orthogonal to and positioned coaxially about the center axis. The retainer member has a contoured external surface and a hollow contoured internal surface inclosing an internal space. Each of the plurality of bearing means at least partially extends above the contoured external surface and at least partially extends through the hollow contoured internal surface into the internal space. The housing has an annular space adapted for coaxially enclosing the first shaft module, the retainer member, and the second shaft module. The housing is adapted to permit the first proximal end of the first shaft member and the second distal end of the second shaft member to extend outwardly along the center axis from the housing to permit the rotation of the first shaft member and the second shaft member. The positioning means for positioning the second shaft module within the housing is adapted to permit the proximal end of the second shaft member to contact each of the plurality of bearing means in the internal space of the retainer member with sufficient pressure to transfer torque from the second shaft member to the first shaft member. Either the retainer member is maintained in a non-rotating position within the housing, or the retainer member is disposed on the distal end of the first shaft member and the housing is adapted to permit the rotation of the retainer member while maintaining the alignment of the first shaft member and the second shaft member on the center axis.

In a further embodiment, the present invention is speed reducer/increaser organized about a center axis. The speed reducer/increaser comprises a first shaft member, a plurality of bearing means, a retainer member, a second shaft member, a cylindrical adaptor, and a housing. The first shaft member has a proximal end and a distal end. The distal end of the first shaft member terminates in a cylindrical rotational housing about the center axis. The cylindrical rotational housing encloses a generally contoured internal bearing surface which broadens toward the distal end. The retainer member has an outer surface, an upper surface, a generally contoured center section, and a flange. The center section has an external contoured surface and a hollow internal contoured zone and is adapted to retain each of the plurality of bearing means in a plane that is orthogonal to and positioned coaxially about the center axis. Each of the plurality of bearing means extends through the contoured external surface and into the hollow internal contoured zone. The retainer member adapted to be at least partially enclosed by said cylindrical rotational housing permitting each of the plurality of bearing means to be in contact said generally contoured internal bearing surface of the cylindrical rotational housing about the center axis at a first contact surface of each bearing means. The flange extends outwardly about the center axis orthogonally beyond the cylindrical rotational housing. The second shaft member is positioned coaxially with the first shaft member. The second shaft member has a second proximal end and a second distal end. The second proximal end is adapted to contact each of the plurality of bearing means extending into the hollow internal contoured zone of the retainer member at a second contact surface of each bearing means. The cylindrical adaptor has a bore. The bore is coaxial with the center axis and has a proximal bearing recess and a distal bearing recess, wherein each bearing recess is adapted to accommodate a bearing. A center wall separates the proximal bearing recess and the distal recess. The center wall has a hole adapted to accommodate the rotation of the second shaft member. The cylindrical adaptor is disposed on the second shaft member. The housing is positioned about the center axis. The housing has an upper housing section and a lower housing section that at least partially encloses and surrounds the cylindrical rotational housing, the plurality of bearing means, the retainer member, and the cylindrical adaptor. The flange of the retainer member is rigidly positioned between the upper housing section and the lower housing section. The upper housing section has a housing bore which is coaxial with the center axis. The housing bore has a proximal zone and a distal zone. The proximal zone has a first bearing recess and a second bearing recess which are separated by a proximal zone wall. The proximal zone wall has a proximal bore which is adapted to accommodate the rotation of the first shaft member. The distal zone is adapted to accommodate the rotation of the cylindrical housing. The cylindrical adaptor is adjustably positioned in the lower housing section. The first shaft member is capable of having a rotational speed about the center axis that is different from a rotational speed of the second shaft member.

In a still further embodiment, the invention is a speed reducer/increaser organized about a center axis comprising a plurality of bearing means, a first shaft member, a second shaft member, and a housing. The first shaft member has a proximal end and a distal end. The distal end terminates in a generally contoured retainer member about the center axis. The retainer member has an external contoured surface and a hollow internal contoured zone, and is adapted to retain each of the plurality of bearing means in a plane that is orthogonal to and positioned coaxially about the center axis. Each of the bearing means extends above the external contoured surface and below into the hollow internal contoured zone. The second shaft member is positioned coaxially with the first shaft member The second shaft member has a second proximal end and a second distal end. The second proximal end is adapted to contact each of the plurality of bearing means which extend into the hollow internal contoured zone of the retainer member. The housing is positioned about the center axis. The housing comprises an upper housing section and a lower housing section. The upper housing section has a contoured interior zone which has an internal bearing surface that at least partially encloses and surrounds the generally contoured retainer member permitting each of the plurality of bearing means to be in contact the internal bearing surface and is positioned about the center axis. The lower housing section at least partially encloses and surrounds the second shaft member and is rigidly attached to the upper housing section. The first shaft member is capable of having a rotational speed about the center axis that is different from a rotational speed of the second shaft member.

### BRIEF DESCRIPTION OF THE DRAWINGS

FIG. 1 is an exploded view of the second embodiment of the invention with a non-rotating retainer.

FIG. 2 shows the second embodiment of the invention, wherein (a) is a frontal view and (b) cross-sectional view taken along line 2A-2A in (a).

FIG. 3 is an exploded view of the first embodiment of the invention with a rotating retainer.

FIG. 4 shows the first embodiment of the invention, wherein (a) is a frontal view and (b) cross-sectional view taken along line 4B-4B in (a).

FIG. 5 shows a cross-sectional view of an alternative embodiment of a non-rotating adaptor of the instant invention, herein showing a 3-stage adaptor assembly.

FIG. 6 shows a cross-sectional view of an alternative embodiment of a non-rotating adaptor of the instant invention, herein showing a 2-stage adaptor assembly.

### DETAILED DESCRIPTION OF THE INVENTION

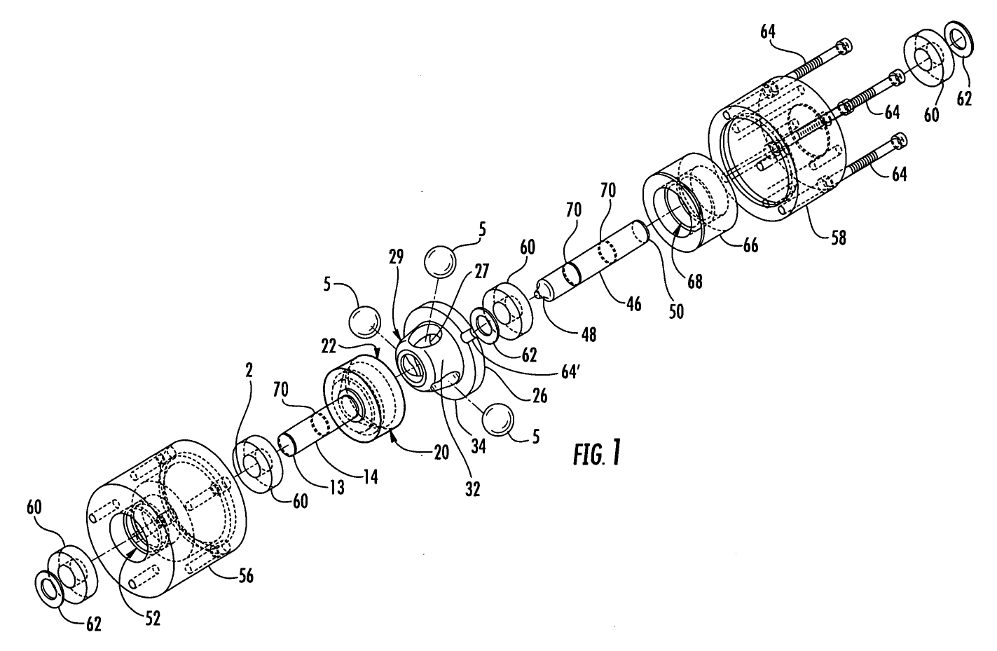

With reference to FIG. 1, an exploded view of a speed reducer/increaser of the present invention having a non-rotating retainer is shown. The invention is a speed reducer/increaser organized about a center axis comprising a first shaft member 14, a plurality of bearing means 5, a retainer member 26, a second shaft member 46, a cylindrical adaptor 66, and a housing (56 upper housing section, 58 lower housing section). The plurality of bearing means 5 can be a plurality of ball bearings or cylinders or tapered rollers. As used herein, a plurality of bearing means is at least two such bearing means. The first shaft member 14 has a proximal end 13 and a distal end 22, and the distal end 22 terminates in a cylindrical rotational housing 20 about the center axis 2. The cylindrical rotational housing 20 encloses a generally contoured internal bearing surface 19 and broadens toward the distal end 22. The retainer member 26 has an external contoured surface 32, generally contoured center section 29, and a flange 34. The generally contoured center section 29 has a hollow internal contoured zone 27 and is adapted to retain each of the plurality of bearing means 5 in a plane that is orthogonal to and positioned coaxially about the center axis. Each of the bearing means 5 extends at least partially through the external contoured surface 32 and at least partially into the hollow internal contoured zone 27. The retainer member 26 is adapted to be at least partially enclosed by the cylindrical rotational housing 20 permitting each of the plurality of bearing means 5 to be in contact with the generally contoured internal bearing surface 19 of the cylindrical rotational housing 20 about the center axis 2 at a first contact surface of each bearing means. The flange 34 extends radially outward from the cylindrical rotational housing 20 and is rigidly fixed between the upper housing section 56 and the lower housing section 58. The retainer member 26 is rigidly fixed in place between the upper housing and lower housing sections 56 and 58, respectively, and not permitted to rotate. In one embodiment, flange 34 is notched (see notch 64′) to engage with the plurality of fasteners 64 to prevent the rotation of the retainer member 26 relative to the upper and lower housing sections 56 and 58. Alternatively, the retainer member 26 can be notched to engage either the upper or the lower housing sections 56 and 58, and the upper and lower housing sections 56 and 58 are rigidly fixed to prevent rotation of the retainer member 26 by means of a clamp (not shown). The second shaft member 46, or input shaft, is positioned coaxially with the first shaft member 14. The second shaft member 46 has a second proximal end 48 and a second distal end 50. The second proximal end 48 is adapted to an outside contour of the bearing means 5 and contacts each of the plurality of bearing means 5 in the hollow internal contoured zone 27 of the retainer member 26 at a second contact surface of each bearing means 5. The cylindrical adaptor 66 has a bore, and the bore is coaxially aligned with the center axis 2 and has a proximal bearing recess 68 and an optional distal bearing recess 69. Each bearing recess (68, and the optional bearing recess 69) is adapted to accommodate a shaft bearing 60, and a center wall 67 separates the proximal bearing recess 68 and the optional distal bearing recess 69. When only a single bearing 60 is used, only a single bearing recess 68 is provided. The center wall 67 has a hole adapted to accommodate the rotation of the second shaft member 46. The second shaft member 46 is positioned and aligned within the hole in the center wall 67 by the shaft bearings 60 disposed in the proximal bearing recess 68 and the distal bearing recess 69. Each of the shaft bearings 60 are secured by a retainer ring 62 disposed on the second shaft member in a recess 70 to laterally position the second shaft member 46 within the cylindrical adaptor 66. The cylindrical adaptor 66 is disposed on the second shaft member 46. The housing (56, 58) is positioned about the center axis. The housing may be tubular, cylindrical, open cage, or any other shape. The housing (upper housing section 56, lower housing section 58) has an upper housing section 56 and a lower housing section 58. The upper housing section 56 at least partially encloses and surrounds the cylindrical rotational housing 20, the plurality of bearing means 5, the retainer member 26, and the cylindrical adaptor 66. The flange 32 of the retainer member 26 is rigidly positioned between the upper housing section 56 and the lower housing section 58, thereby preventing the rotation of the retainer member 26. A plurality of fasteners 64 which are equidistantly disposed about the center axis extending through the lower housing section 58 and are secured to the lower housing section 58.

In a simplified variation of the instant invention, referring to FIG. 1, the features of the cylindrical adaptor 66 are incorporated into the lower housing section 58 as a single rigid body lower housing having at least one bearing recess (i.e., proximal bearing recess 68 and/or distal bearing recess 69), wherein the bearing recess is adapted to accommodate a shaft bearing 60. In this embodiment, a positioning means (not shown) is used for positioning the second shaft member 46 within the single rigid body lower housing to restrict lateral movement of the second shaft member along the center axis. The positioning means can be any means for adjustably positioning the second shaft member 46, including a manual adjustment to compensate for wear, or a pressure device like compression springs or a contoured spring washer to keep the bearing means 5 in the retainer member 26 and second shaft member 46 in constant pressure.

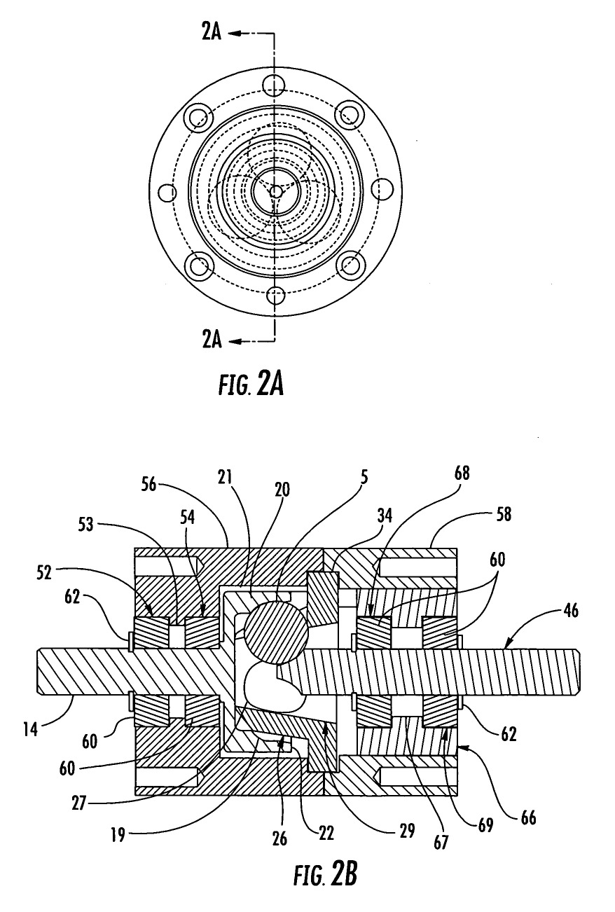

FIG. 2(a) shows the front view of the speed reducer/increaser of the present invention having a non-rotating retainer. In FIG. 2(b), the cross-sectional view taken along line 2A-2A in 2(a), the upper housing section 56 has a housing bore which is coaxial with the center axis, and has an upper housing proximal zone and an upper housing distal zone. The upper housing proximal zone has a first bearing recess 52 and a second bearing recess 54 separated by an upper housing proximal zone wall 53. The proximal zone wall 53 has a proximal bore adapted to accommodate the rotation of the first shaft member 14. The first shaft member shaft 14 is laterally positioned and aligned within the proximal bore in the proximal zone wall 53 by the shaft bearings 60 disposed in the upper housing proximal bearing recess 52 and the upper housing distal bearing recess 53. The shaft bearings 60 are secured by a retainer ring 62 disposed on the first shaft member 14 in a recess 70, or by a shoulder raised on the first shaft member 14, or by some other retaining means such as a pin or a key. The upper housing distal zone 21 is adapted to enclose and accommodate the rotation of the cylindrical rotational housing 20.

It is important that the cylindrical adaptor 66 be rigidly positioned within the lower housing section 58, but it also important to adjust the position of the cylindrical adaptor 66 and second shaft member 46 to maintain sufficient pressure and contact with the bearing means. Thus, the cylindrical adaptor 66 is adjustably positioned in the lower housing section 58 by a positioning means to maintain effective contact and effective constant pressure between the proximal end 48 of the second shaft member 46 and the plurality of bearing means 5. The positioning means can be any means for adjustably positioning the cylindrical adaptor 66 including a manual adjustment to compensate for wear, or a pressure device like compression springs or a contoured spring washer to keep the assembly comprising the cylindrical adaptor 66 and second shaft member 46 in constant pressure. One such positioning means for manual adjustment comprises disposing threads (not shown) on an outer cylindrical surface of the cylindrical adaptor and disposing threads (not shown) on the inner surface of the lower housing section 58 and providing a screwdriver slot or spanner holes on the distal end (not shown) to move the second shaft member, or input shaft, into tighter (or looser) mesh with the bearing means.

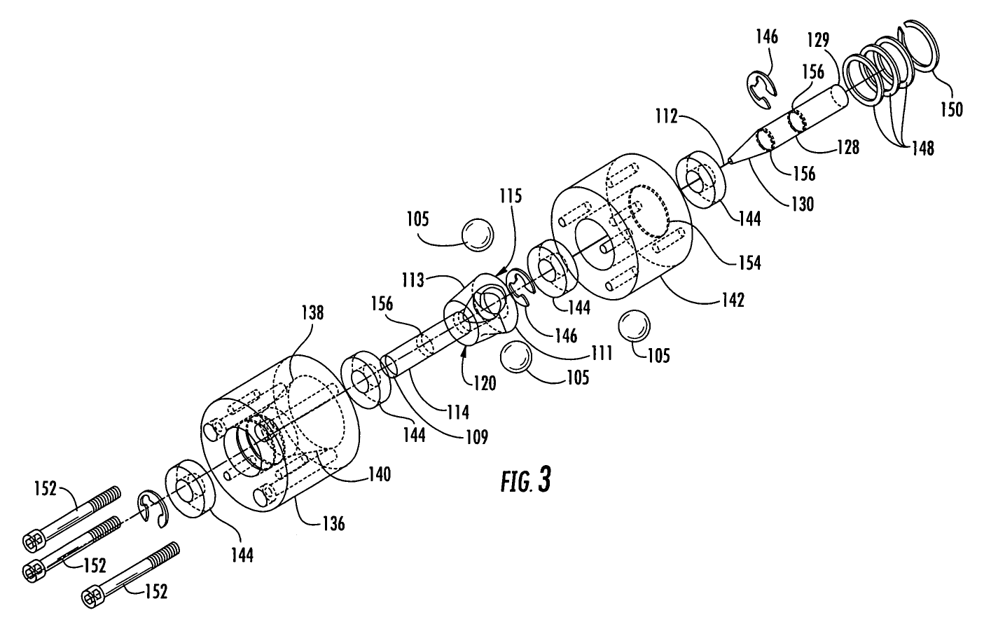

With reference to FIG. 3, an exploded view of a speed reducer/increaser of the present invention having a rotating retainer is shown. The invention is a speed reducer/increaser organized about a center axis comprising a plurality of bearing means 105, a first shaft member 114, a second shaft member 128, and a housing (having an upper housing 136 and a lower housing 142). The plurality of bearing means 105 can be a plurality of ball bearings or cylinders or tapered rollers. As used herein, a plurality of bearing means 105 is at least two such bearing means. The first shaft member 114, or output shaft member, has a proximal end 109 and a distal end 111. The distal end terminates in a generally contoured retainer member 120 about the center axis 112. The generally contoured retainer member 120 has an external contoured surface 113 and a hollow internal contoured zone 115. The generally contoured retainer member 120 is adapted to retain each of the plurality of bearing means 105 in a plane that is orthogonal to and positioned coaxially about the center axis 112. Each of the bearing means 105 at least partially extends above the external contoured surface 113 and each of the bearing means at least partially extends into the hollow internal contoured zone 115. The second shaft member 128 is positioned coaxially with the first shaft member 114. The second shaft member 128 has a second proximal end 130 and a second distal end 129. The second proximal end 130 is tapered toward the second proximal end 130. The second proximal end 130 is positioned to contact each of the plurality of bearing means 105 and extends into the hollow internal contoured zone 115 of the generally contoured retainer member 120. The housing (upper housing section 136, lower housing section 142) is positioned coaxially about the center axis and comprises an upper housing section 136 and a lower housing section 142. The upper housing section 136 has a contoured interior zone 138 which has an internal bearing surface 140 that encloses and surrounds the generally contoured retainer member 120 permitting each of the plurality of bearing means 105 to be in contact the internal bearing surface 140 and positioned about the center axis. The lower housing section 142 at least partially encloses and surrounds the second shaft member 128. The second shaft member 128 is laterally positioned in the lower housing section 142 to place the proximal end 130 of the second shaft member 128 in contact with the portion of bearing means 105 extending into the hollow internal contoured zone 115 of the generally contoured retainer member 120. A plurality of fasteners 152 which are equidistantly disposed about the center axis extend through the upper housing section 136 and are secured to the lower housing section 142.

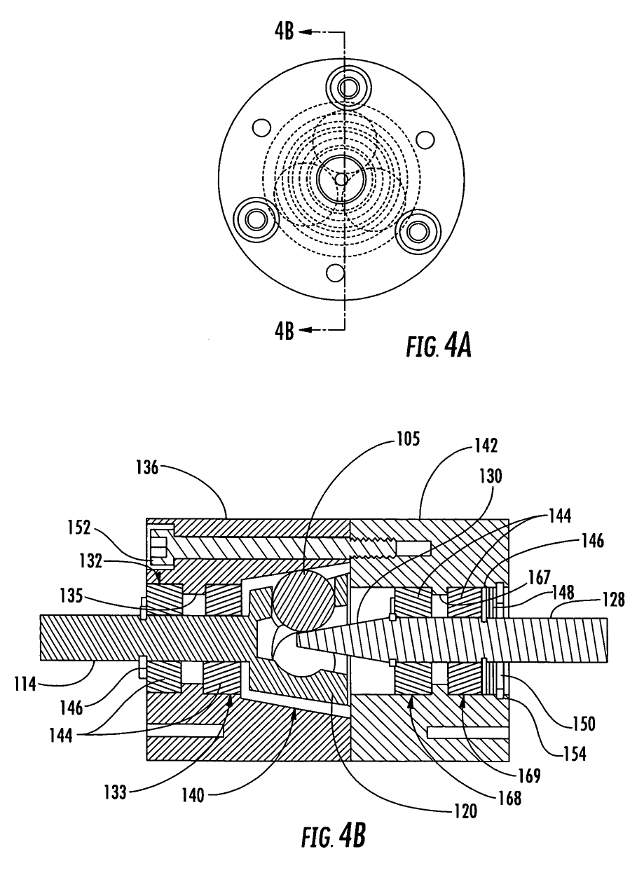

FIG. 4 shows the second embodiment of the invention, wherein 4(a) is a frontal view, and 4(b) cross-sectional view taken along line 4A-4A in 4(a). In FIG. 4(b) the upper housing section 136 has a housing bore which is coaxial with the center axis, and has an upper housing proximal zone and an upper housing distal zone. With reference to FIG. 4(b) the upper housing section 136 has a housing bore which is coaxial with the center axis, and has an upper housing proximal zone and an upper housing distal zone. The upper housing proximal zone has a first bearing recess 132 and a second bearing recess 133 separated by an upper housing zone wall 135. The upper housing zone wall 135 has a shaft bore adapted to accommodate the rotation of the first shaft member 114. The first shaft member shaft 114 is positioned and aligned within the shaft bore in the upper housing zone wall 135 by the shaft bearings 144 disposed in first bearing recess 132 and a second bearing recess 135. The shaft bearing 144 is laterally secured by a retainer ring 146 disposed on the first shaft member 114 in a shaft recess 156 (See FIG. 3). The upper housing distal zone is adapted to accommodate the rotation of the generally contoured retainer member 120. The lower housing section 142 has a bore, and the bore is coaxial with the center axis and has a proximal bearing recess 168 and a distal bearing recess 169. Each bearing recess (168, 169) is adapted to accommodate a shaft bearing 144, and a center wall 167 separates the proximal bearing recess 168 and the distal bearing recess 169. The center wall 167 has a hole adapted to accommodate the rotation of the second shaft member 128. The second shaft member 128 is positioned and aligned within the hole in the center wall 167 by the shaft bearings 144 disposed in the proximal bearing recess 168 and the distal bearing recess 169. Each of the shaft bearings 144 are secured by a retainer ring 146 disposed on the second shaft member 128 in recesses 156 (See FIG. 3). The second shaft member 128 is longitudinally aligned within the lower housing section 142 by at least 1 spring ring 148 and one or more spring retainer ring 150 in recess 154 to maintain effective contact and pressure on the second proximal end 130 of the second shaft member 128 to apply pressure to the plurality of bearing means 105. In an alternate embodiment, at least one or more of the at least one spring ring 148 and one or more spring retainer ring 150 is replaced with a positioning means (not shown in FIG. 3, but similar to the cylindrical adaptor 66, shown in FIG. 1) for manual adjustment of the pressure. The positioning means has a cylindrical body having an outer cylindrical surface, an inside end, an outside end, and a shaft bore coaxial with the center axis. The shaft bore is adapted to accommodate the second shaft member 128, and the positioning means is adapted to be accommodated within recess 154. Threads disposed on the outer cylindrical surface of the positioning means and threads disposed on the inner surface of the lower housing section 142 are adapted to permit the adjustment of the pressure on the second proximal end 130 of the second shaft member 128 to apply pressure to the plurality of bearing means 105. A screwdriver slot or spanner holes disposed on the outside end of the positioning means facilitates manual adjustment to move the second shaft member 128 into tighter (or looser) mesh with the bearing means 105.

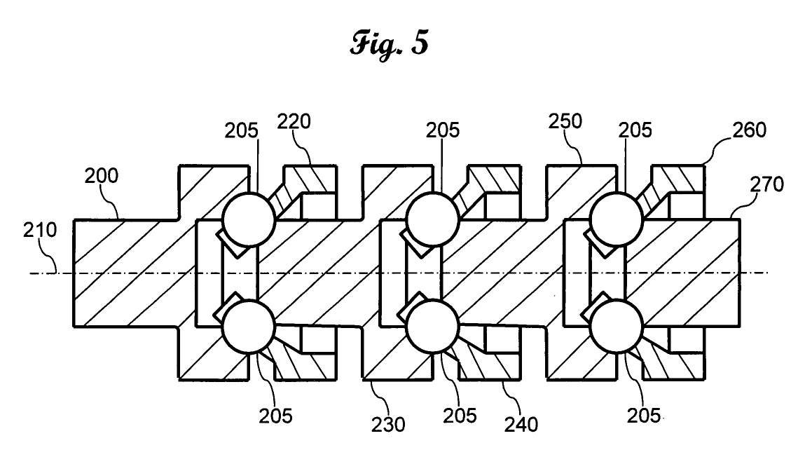

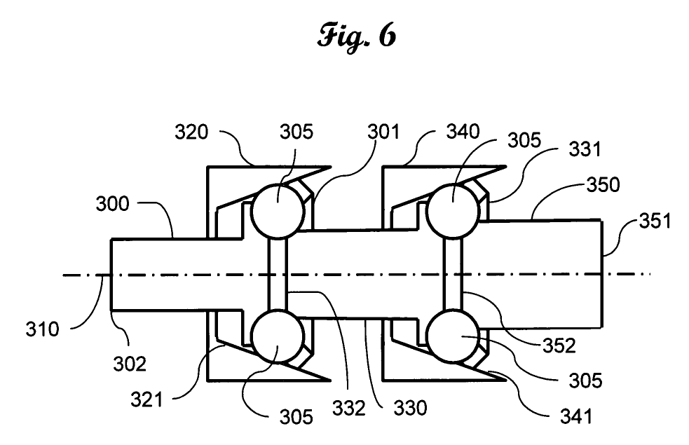

Additionally, the speed reducer/increaser of the present invention in either of the above embodiments wherein the retainer means is permitted to rotate, or wherein the retainer means is non-rotating can be assembled in stages by use of a modular assembly/design method. A “stage” would represent the assembly of one or more bearing means and one or more retainer means that may or may not be permitted to rotate about the centerline. Furthermore, the retainer member may comprise one or more intermediate stage transmission modules. When present, the intermediate stage transmission module is disposed between the retainer member and the proximal end of the second shaft member. Each of the at least one intermediate stage transmission module comprises a plurality of intermediate stage bearing means, an intermediate stage shaft member disposed coaxially with the first shaft member, and an intermediate stage retainer. The intermediate shaft member has an intermediate stage proximal end adapted to contact each of the plurality of bearing means in the retainer member and has an intermediate stage distal end. The intermediate stage retainer member is disposed coaxially with the first shaft member. The intermediate stage retainer member has a generally contoured intermediate external surface and an intermediate hollow internal contoured zone inclosing an intermediate internal space. Each of the plurality of shaft bearing means is retained in the intermediate stage retainer member such that each shaft bearing means at least partially extends above the contoured intermediate external surface and at least partially extends through the intermediate hollow contoured internal surface into the intermediate internal space. Furthermore, the intermediate internal space is adapted to contact a proximal end of an adjacent intermediate stage transmission module or the second proximal end of the second shaft member. The intermediate shaft retainer member will be either a rotating retainer member or a non-rotating member according to whether the initial retainer member is a rotating retainer member or a non-rotating retainer member. The intermediate stage transmission module is non-rotating when the retainer member is non-rotating. The intermediate stage transmission module is rotating when the retainer member is rotating. These alternatives are illustrated in FIG. 5 and FIG. 6 and further discussed hereinbelow.

FIG. 5 represents a cross section of an alternate embodiment of the non-rotating retainer member/second shaft module described in FIG. 1, herein shown as a 3-stage assembly using two intermediate stage transmission modules. In the multi-stage arrangement shown, an axial force applied to any shaft member in the 3-stage assembly is transmitted to the adjacent shaft member to transmit torque and/or rotational motion to an adjacent shaft member. In this embodiment, the retainer members are non-rotating. Referring to FIG. 5, a first stage comprises a first stage shaft member 200, a plurality of bearing means 205, and a first stage retainer member 220 retaining the bearing means 205 coaxially about a centerline 210. The second stage comprises a second shaft member 230, a plurality of bearing means 205, and a second stage retainer member 240 retaining the plurality of bearing means 205 coaxially about the centerline 210. The third stage comprises a third stage shaft member 250, a plurality of bearing means 205, and a third stage retainer member 260 retaining the bearing means 205 coaxially about the centerline 210. A fourth shaft member 270 is disposed coaxially about the center axis with sufficient pressure along the center axis to contact the plurality of bearing means 205 in the third stage retainer member 260. All shaft members 200, 230, 240, and 270 have the same centerline axis and are coaxial with the retainer members 220, 240, and 260 about centerline 210. As disclosed hereinabove, the opposing ends of the shaft members 230, 240, and 270 are contoured to provide an effective contact surface with the plurality of bearing means in each stage. It is believed that the contours on either end of any intermediate shaft members, i.e., 230 and 250, will act to maintain their radial position concentric with the rest of the assembly. The intermediate shaft members 230 and 250 do not require ball bearings or bushings to maintain their radial position coincident with the centerline of the other shafts; however, such supporting elements may be used. Thus, an axial force applied to the forth shaft member 270 will transmit torque or rotational motion to shaft members 250, 230, and 200. By varying the effective diameters of the shaft members and the within the 3-stage module, a speed increase or a speed decrease across the 3-stage module between the first stage shaft member 210 and the fourth shaft member 270 can be achieved.

FIG. 6 represents a cross section of an alternate embodiment of the rotating retainer member/second shaft module in FIG. 3 shown as a 2-stage assembly one intermediate stage transmission module. In the multi-stage arrangement shown in FIG. 6, an axial force applied to any shaft member in the 2-stage assembly is transmitted to the adjacent shaft member to transmit torque and/or rotational motion to an adjacent shaft member and retainer member. Referring to FIG. 6, a first stage comprises a first stage shaft member 300 having a first stage shaft proximal end 302 and having an integral first stage retainer member 301, a plurality of bearing means 305, wherein the integral first stage retainer member 301 retains the bearing means 305 coaxially in a fixed orbit about a centerline 310. The first stage shaft member 300 having the integral first stage retainer member 301 is disposed within a first upper housing section 320 having a contoured bearing surface 321 adapted to contact the bearing means 305 and permit the rotation of the first shaft member 300. The second stage comprises a second stage shaft member 330 having a second stage proximal end 332, and, at a second stage distal end, an integral second stage retainer member 331, a plurality of bearing means 305. The second stage shaft member 330 having the integral second stage retainer member 331 is disposed within a second upper housing section 340 having a contoured bearing surface 341 adapted to contact the bearing means 305 and permit the rotation of the second shaft member 340. The second shaft member 340 retaining the plurality of bearing means 305 coaxially in a fixed orbit about a centerline 310. A third stage shaft member 350 having a third stage shaft proximal end 352 and a third stage shaft distal end 351 is disposed coaxially about the center axis with sufficient pressure along the center axis 310 to contact the plurality of bearing means 305 in the second stage retainer member 331. All staged shaft members: 300, 330, and 350 share, or are disposed on the same centerline and are coaxial with the retainer members 301, and 331 about centerline 310. As disclosed hereinabove, proximal ends 332 and 352 of the shaft members 330 and 350, respectively, are contoured to provide an effective contact surface with the plurality of bearing means 305 in each stage. It is believed that the contours on the second and third shaft members 330 and 350 will act to maintain their radial position concentric with the rest of the assembly. Thus, the intermediate shaft members 330 and 350 do not require ball bearings or bushings to maintain their radial position coincident with the centerline of the other shafts; however, such supporting elements may be used. Thus, an axial force applied to the forth shaft member 350 will transmit torque or rotational motion to shaft members 330 and 300. By varying the effective diameters of the shaft members and the within the 2-stage module, a speed increase or a speed decrease across the 2-stage module between the first stage shaft member 300 and the third shaft member 350 can be achieved.

It is important that in each embodiment that there be an effective amount of axial force applied to each multi-stage arrangement or shaft/retainer combination within each stage of the present invention to provide the motion or rotation throughout the staged shaft member/retainer member combination. In this manner the axial force can be transmitted through all stages. Although a single positioning means for a multi-stage arrangement is sufficient, it is preferred that a positioning means for each individual stage be provided to apply an effective amount of axial force in each stage. Furthermore, the positioning means should be adjustable to compensate for wear of the components. Preferably, the positioning means should be individually adjustable across each stage in a multi-stage arrangement. The positioning means for each individual stage may be any means for adjustably positioning the shaft member relative to the retainer member including a manual adjustment to compensate for wear, or a pressure device like compression springs or a contoured spring washer to keep the staged shaft member/retainer member combination in constant pressure.

The speed reducer/increaser of the present invention can be fastened to other equipment by attaching the housing to the other equipment by a plurality of conventional fasteners at points positioned radially and evenly distributed about the upper housing zone or the lower housing zone on the outside ends of the housing.

What is claimed is:

1. A speed reducer/increaser organized about a center axis comprising:
a. a plurality of bearing means;
b. a first shaft member module comprising a first shaft member having a first shaft proximal end and a first shaft distal end, and a first shaft bearing means disposed on the first shaft member coaxially;
c. a second shaft module comprising a second shaft member having a second proximal end and a second distal end, a second shaft bearing means disposed on the second shaft member coaxially and wherein the second proximal end of the second shaft module is adapted to contact each of the plurality of bearing means;
d. a retainer member adapted to retain and permit the rotation of each of the plurality of bearing means in a plane that is orthogonal to and positioned coaxially about the center axis, said retainer member having a contoured external surface and a hollow contoured internal surface inclosing an internal space, wherein each of the plurality of bearing means at least partially extends above the contoured external surface and at least partially extends through the hollow contoured internal surface into the internal space;
e. a housing having an annular space adapted for coaxially enclosing the first shaft module, the retainer member, and the second shaft module, wherein the housing is adapted to permit the first proximal end of the first shaft member and the second distal end of the second shaft member to extend outwardly along the center axis from the housing to permit the rotation of the first shaft member and the second shaft member;
f. a positioning means for positioning the second shaft module within the housing to permit the proximal end of the second shaft member to contact each of the plurality of bearing means in the internal space of the retainer member with sufficient pressure to transfer torque from the second shaft member to the first shaft member; and,
g. wherein the retainer member is maintained in a non-rotating position within the housing, or wherein the retainer member is disposed on the distal end of the first shaft member and the housing is adapted to permit the rotation of the retainer member while maintaining the alignment of the first shaft member and the second shaft member on the center axis.

2. The speed reducer/increaser of claim 1, wherein the plurality of bearing means are selected from the group consisting of ball bearings, rollers, and tapered pins.

3. The speed reducer/increaser of claim 1, wherein the retainer member is non-rotating.

4. The speed reducer/increaser of claim 1, wherein the retainer member is rotating.

5. The speed reducer/increaser of claim 1, wherein the plurality of bearing means comprises at least 2 ball bearings.

6. The speed reducer/increaser of claim 1, wherein the positioning means for positioning the second shaft module within the housing is a spring washer.

7. The speed reducer/increaser of claim 1, wherein the first shaft bearing means comprises a first proximal shaft bearing and a first distal shaft bearing, wherein the first proximal shaft bearing and the first distal shaft bearing are disposed on the first shaft member coaxially and separated by a first member retainer wall having a first bore adapted to permit the rotation of the first shaft member about the center axis.

8. The speed reducer/increaser of claim 1, wherein the second shaft bearing means comprises a second proximal shaft bearing, and a second distal shaft bearing, wherein the second proximal shaft bearing and the second distal shaft bearing are disposed on the second shaft member coaxially and separated by a second wall having a second bore adapted to permit the rotation of the second shaft member about the center axis

9. The speed reducer/increaser of claim 1, wherein the positioning means for positioning the second shaft module within the housing is a cylinder member enclosing the second shaft member, said cylinder having a threaded outside surface and wherein the housing has a threaded inside surface and the position of the second shaft module is manually changed to sufficient pressure of the second proximal end of the second shaft member on each of the plurality of bearing means in the retainer member.

10. The speed reducer/increaser of claim 1, wherein the positioning means further comprises at least one spring washer.

11. The speed reducer/increaser of claim 1, wherein the housing is tubular.

12. The speed reducer/increaser of claim 1, further comprising at least one intermediate stage transmission module disposed between the retainer member and the proximal end of the second shaft member, each of the at least one intermediate stage transmission module comprising:
a. a plurality of intermediate stage bearing means;
b. an intermediate stage shaft member disposed coaxially with the first shaft member, said intermediate shaft member having an intermediate stage proximal end adapted to contact each of the plurality of bearing means in said retainer member and having an intermediate stage distal end;
c. an intermediate stage retainer member disposed coaxially with the first shaft member, said intermediate stage retainer member having a generally contoured intermediate external surface and an intermediate hollow internal contoured zone inclosing an intermediate internal space, wherein each of the plurality of shaft bearing means at least partially extends above the contoured intermediate external surface and at least partially extends through the intermediate hollow contoured internal surface into the intermediate internal space; and,
d. wherein the intermediate internal space is adapted to contact a proximal end of an adjacent intermediate stage transmission module or the second proximal end of the second shaft member.

13. The speed reducer/increaser of claim 8, wherein the intermediate stage transmission module is non-rotating when the retainer member is non-rotating.

14. The speed reducer/increaser of claim 8, wherein the intermediate stage transmission module is rotating when the retainer member is rotating.

15. A speed reducer/increaser organized about a center axis comprising:
a first shaft member having a proximal end and a distal end, said distal end terminating in a cylindrical rotational housing about the center axis, said cylindrical rotational housing enclosing a generally contoured internal bearing surface broadening toward the distal end;
a plurality of bearing means;
a retainer member having an outer surface, an upper surface, a generally contoured center section, and a flange, said center section having an external contoured surface and a hollow internal contoured zone and being adapted to retain each of the plurality of bearing means in a plane that is orthogonal to and positioned coaxially about the center axis, each of said bearing means extending through the contoured external surface and into the hollow internal contoured zone, said retainer member adapted to be at least partially enclosed by said cylindrical rotational housing permitting each of the plurality of bearing means to be in contact with said generally contoured internal bearing surface of the cylindrical rotational housing about the center axis at a first contact surface of each bearing means, said flange extending outwardly about the center axis orthogonally beyond the cylindrical rotational housing;
a second shaft member positioned coaxially with the first shaft member, said second shaft member having a second proximal end and a second distal end, said second proximal end adapted to contact each of the plurality of bearing means extending into the hollow internal contoured zone of the retainer member at a second contact surface of each bearing means;
a cylindrical adaptor having a bore, said bore being coaxial with the center axis and having a proximal bearing recess and a distal bearing recess each bearing recess adapted to accommodate a bearing, and a center wall separating the proximal bearing recess and the distal recess, said center wall having a hole adapted to accommodate the rotation of the second shaft member, said cylindrical adaptor being disposed on the second shaft member;
a housing positioned about the center axis, said housing having an upper housing section and a lower housing section that at least partially encloses and surrounds the cylindrical rotational housing, the plurality of bearing means, the retainer member, and the cylindrical adaptor, said flange of the retainer member being rigidly positioned between the upper housing section and the lower housing section, said upper housing section having a housing bore being coaxial with the center axis, said housing bore having a proximal zone and a distal zone, said proximal zone having a first bearing recess and a second bearing recess separated by a proximal zone wall, said proximal zone wall having a proximal bore adapted to accommodate the rotation of the first shaft member; said distal zone being adapted to accommodate the rotation of the cylindrical housing, said cylindrical adaptor being adjustably positioned in the lower housing section; and,
wherein the first shaft member is capable of having a rotational speed about the center axis that is different from a rotational speed of the second shaft member.

16. A speed reducer/increaser organized about a center axis comprising:
a plurality of bearing means;
a first shaft member having a proximal end and a distal end, said distal end terminating in a generally contoured retainer member about the center axis, said retainer member having an external contoured surface, and a hollow internal contoured zone and being adapted to retain each of the plurality of bearing means in a plane that is orthogonal to and positioned coaxially about the center axis, each of said bearing means extending above the external contoured surface and below into the hollow internal contoured zone;
a second shaft member positioned coaxially with the first shaft member, said second shaft member having a second proximal end and a second distal end, said second proximal end adapted to contact each of the plurality of bearing means extending into the hollow internal contoured zone of the retainer member;
a housing positioned about the center axis, said housing comprising:
an upper housing section having a contoured interior zone having an internal bearing surface that at least partially encloses and surrounds the generally contoured retainer member permitting each of the plurality of bearing means to be in contact said internal bearing surface and positioned about the center axis and a lower housing section that at least partially encloses and surrounds the second shaft member and being rigidly attached to the upper housing section; and,
wherein the first shaft member is capable of having a rotational speed about the center axis that is different from a rotational speed of the second shaft member.
